(19) United States
(12) Patent Application Publication
(10) Pub. No.: US 2008/0059394 A1
(43) Pub. Date: Mar. 6, 2008

(54) Predicting Continuous Positive Airway Pressure Titration Using An Artificial Neural Network

(76) Inventor: Ali El Solh, Orchard Park, NY (US)

Correspondence Address: HODGSON RUSS LLP;THE GUARANTY BUILDING, 140 PEARL STREET, SUITE 100, BUFFALO, NY, 14202-4040, US

(21) Appl. No.: 11/840,889

(22) Filed: Aug. 17, 2007

Related U.S. Application Data
(60) Provisional application No. 60/838,274, filed on Aug. 17, 2006.

(51) Int. Cl. G06N 3/08; G06F 15/18

(52) U.S. Cl. 706/21; 706/16

(57) ABSTRACT

A method of predicting continuous positive airway pressure (“CPAP”) is disclosed. In one such method, an artificial neural network (“ANN”) is created that produces a predicted CPAP. The ANN may be used to produce a CPAP that in turn may be useful in diagnosing and treating a patient with obstructive sleep apnea. Also disclosed are methods of evaluating ANNs for predicting a CPAP based on neck circumference, a body mass index, an apnea-hypopnea index, and an actual effective pressure.

### CROSS REFERENCE TO RELATED APPLICATIONS

This application claims the benefit of U.S. Provisional Patent Application No. 60/838,274 filed on Aug. 17, 2006, which is incorporated by reference herein.

### FIELD OF THE INVENTION

This invention relates to methods of predicting a continuous positive airway pressure titration using an artificial neural network.

### BACKGROUND OF THE INVENTION

Numbers appearing in parentheses identify published documents that are listed in paragraph [0045].

Obstructive sleep apnea (OSA) is relatively common problem with potentially serious health consequences (1). It has been linked to increased risk of mortality and morbidity due to cardiovascular and neurophysiologic disorders (2). Nasal continuous positive airway pressure (CPAP) is considered a well established and evidence based treatment for this disorder (3). Compliance with treatment is associated with enhanced vigilance, improved quality of life, and reduced traffic accidents (4).

Continuous positive airway pressure (“CPAP”) is considered the most effective treatment for obstructive sleep apnea. Many laboratories continue to determine the effective CPAP setting by scheduling a full-night polysomnography. An algorithm that can predict accurately the effective CPAP setting is desirable because it can provide a convenient point for CPAP titration, reduce the number of incremental pressure changes during the night and allow for institution of therapy while awaiting for a formal sleep titration study. A formula (a regression equation) has been developed for that purpose but predicting CPAP pressure prior to titration has been less than optimal. The regression equation was found inaccurate in predicting a prescribed CPAP level.

In order to derive the most effective pressure, CPAP titration may be performed in the sleep laboratory during which the pressure is gradually increased until apneas and hypopneas are abolished in all sleep stages and in all body positions. The technique is however time consuming and labor intensive. Furthermore, the duration of the study may not be sufficient to attain this goal because of patient's poor ability to sleep in this environment or due to difficulty in attaining an appropriate pressure. A predictive algorithm based on demographic, anthropometric, and polysomnographic data was developed to facilitate the selection of a starting pressure during the overnight titration study (5). Yet, the performance of this model was inconsistent when validated by other centers (6,7). One of the potential reasons for the lack of reproducibility is the complex relation of behavioral processes with nonlinear attributes.

An artificial neural network has been found to be superior to available conventional statistical techniques in predicting complex outcomes. However, creating and choosing an artificial neural network that provides a good prediction of CPAP is difficult at best.

### BRIEF SUMMARY OF THE INVENTION

The present invention broadly comprises methods for evaluating artificial neural networks (“ANNs”) for predicting a continuous positive airway pressure, including: a) collecting information from human subjects to provide a dataset that includes an entry for each human subject wherein each entry includes a neck circumference, a body mass index, an apnea-hypopnea index, and an actual effective pressure; b) randomly separating the entries of the dataset into n subsets; c) creating n (where “n” is an integer) unique training sets, wherein each training set has n−1 of the n subsets; d) creating n ANNs, each of the ANNs being created from a different one of the training sets, and being created to provide a predicted effective pressure using information about neck circumference, body mass index and apnea-hypopnea index; e) calculating a mean squared error for each of the n ANNs by comparing the predicted effective pressure to the actual effective pressure for each of the entries; f) calculating an average by averaging the mean squared errors; g) determining which of the mean squared errors is closest to the average; and, h) selecting the ANN corresponding to the mean squared error that is determined to be closest to the average. The selected ANN may be used to predict an effective pressure for treating obstructive sleep apnea.

The mean squared error for an ANN may be calculated by: 1) selecting one of the entries; 2) calculating the predicted effective pressure for the selected entry; 3) calculating an error number, the error number being an error between the actual effective pressure and the calculated predicted effective pressure of the selected entry; 4) repeating the steps 1-3 for each of the entries to provide a plurality of error numbers; and, 5) calculating a mean squared error using the plurality of error numbers.

The entries of the dataset may be separated into n subsets by: 1) assigning each entry a randomly generated number; 2) assigning each of n subsets a range of randomly generated numbers; and, 3) assigning each entry into one of the subsets based on the range and the randomly generated number. The ranges of randomly generated numbers may be arranged to provide an equal number of entries assigned to each of the n subsets.

The ANNs may be created by modifying coefficients of an equation. For example, the equation may be P_{predicted}=X·NC+Y·BMI+Z·AHI+C, wherein P_{predicted} is the predicted pressure for one of the human subjects, NC is the neck circumference for one of the human subjects, BMI is the body mass index for one of the human subjects, AHI is the apnea-hypopnea index for one of the human subjects, and X, Y, Z, and C are the coefficients.

The ANNs may be created by a general regression neural network. The general regression neural network may include an input layer, a hidden layer, and an output layer. The input layer may extract information from each entry of the dataset. The hidden layer may fit an equation to each entry of the dataset. The output layer may provides an estimate equation responsive to the fitted equations for providing the predicted effective pressure.

A general object of the present invention may be to provide an accurate and efficient method for predicting CPAP in patients suffering from obstructive sleep apnea. Other possible objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a flowchart depicting a method according to the invention;

FIG. 2 is a flowchart continuing the method depicted in FIG. 1;

FIG. 3 is a flowchart continuing the method depicted in FIG. 2;

FIG. 4 is a table of characteristics of a study population;

FIG. 5 is a table of a comparison of effective pressures obtained by polysomnography, an artificial neural network, and a regression analysis (median, IQ);

FIG. 6 is a histogram of the differences between effective pressure and predicted optimal pressure by the artificial neural network (A) in a derivation cohort;

FIG. 7 is a histogram of the differences between effective pressure and predicted optimal pressure by the regression equation (B) in a derivation cohort;

FIG. 8 is a histogram of the differences between effective pressure and predicted optimal pressure by the artificial neural network (A) in a validation cohort;

FIG. 9 is a histogram of the differences between effective pressure and predicted optimal pressure by the regression equation (B) in a validation cohort; and,

FIG. 10 is a Bland and Altman graph for effective pressure vs. predicted optimal pressure by the artificial neural network for a study population.

### DETAILED DESCRIPTION OF THE INVENTION

Like drawing numbers on different figures identify identical or functionally similar structural features of the invention. The present invention is described with respect to what is presently considered to be the preferred aspects, but it should be appreciated that the invention as claimed is not limited to the disclosed aspects. The invention is not limited to the particular methodology, materials and modifications described and as such may vary. The terminology used herein is for the purpose of describing particular aspects only, and is not intended to limit the scope of the present invention.

Unless defined otherwise, all technical and scientific terms used herein have the same meaning as commonly understood to one of ordinary skill in the art to which this invention belongs. Any methods, devices or materials similar or equivalent to those described herein can be used in the practice or testing of the invention, but the presently preferred methods, devices, and materials are now described.

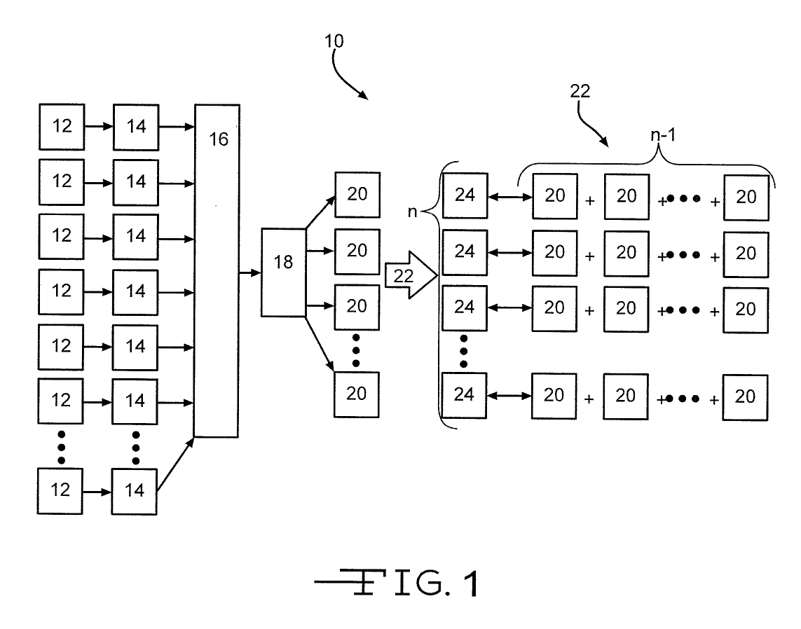

A method for evaluating artificial neural networks (“ANNs”) for predicting a continuous positive airway pressure is depicted generally by flowcharts 10, 11 and 13 of FIGS. 1-3. The method includes collecting information 12 from human subjects to provide entries 14 for a dataset 16. Each entry includes a neck circumference, a body mass index, an apnea-hypopnea index, and an actual effective pressure of the human subject.

The dataset 16 may be randomly separated in process 18 into n subsets 20, where n is an integer. Then, n training sets 24 are created as is illustrated as process 22 in FIG. 1. Each training set 24 may have n−1 of the n subsets 20.

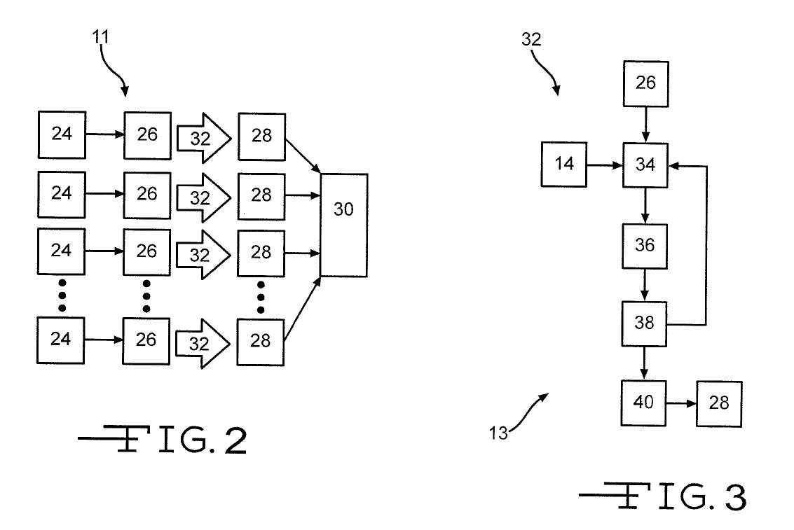

Continuing to FIG. 2, n ANNs 26 and are created to provide a predicted effective pressure using information about neck circumference, body mass index and apnea-hypopnea index. Each of the ANNs 26 may be created from a different one of the training sets 24.

A mean squared error 28 for each of the n ANNs 26 may be calculated by comparing the effective pressure predicted by an ANN 26 to the actual effective pressure for each of the entries as illustrated by process 32. An average 30 may be determined by averaging the mean squared errors 28, and a comparison may be made between the average 30 and the mean squared errors 28 in order to determine which of the mean squared errors 28 is closest to the average 30. The ANN 26 corresponding to the mean squared error 28 that is determined to be closest to the average 30 may be selected. The selected ANN 26 may be used to predict an effective pressure for treating obstructive sleep apnea.

Calculating the mean squared error 28 by process 32 is further depicted in FIG. 3 in which the mean squared error for an ANN 26 may be calculated by selecting one of the entries 14 and calculating the predicted effective pressure 34 for the selected entry 14 using the ANN 26 in question. An error number 36 may be calculated, for example by the equation

$$EN = \vert \frac{AEP - PEP}{AEP} \vert ,$$

where EN is the error number 36, AEP is the actual effective pressure, and PEP is the predicted effective pressure 34. In that equation, the error number 36 represents the error between the actual effective pressure collected in entry 14 and the calculated predicted effective pressure 34 of the selected entry 14. A repeat string 38 may be provided to repeat part of process 32 until each of the entries 14 has been processed and thereby provide a plurality of error numbers 40. From the plurality of error numbers 40, the mean squared error 28 may be determined.

The separation of the dataset 16 occurring in process 18 into the n subsets 20 may be accomplished by assigning each entry 14 a randomly generated number then assigning each of n subsets 20 a range of randomly generated numbers. Then each entry 14 may be assigned into one of the subsets 20 by process 18 based on whether its corresponding randomly generated number falls within the assigned range. The process 18 may also be arranged to ensure the ranges of randomly generated numbers are arranged to provide an equal number of entries 14 assigned to each of the n subsets 20.

The ANNs 26 may be created by modifying coefficients of an equation, such as P_{predicted}=X·NC+Y·BMI+Z AHI+C, wherein P_{predicted} is the predicted pressure for one of the human subjects, NC is the neck circumference for one of the human subjects, BMI is the body mass index for one of the human subjects, AHI is the apnea-hypopnea index for one of the human subjects, and X, Y, Z, and C are the coefficients.

The coefficients of the ANNs 26 may be determined by using a general regression neural network. The general regression neural network may include an input layer, a hidden layer, and an output layer. The input layer may extract the information contained with each entry of the dataset. The hidden layer may fit an equation to each entry of the dataset, and the output layer may provide an estimate equation responsive to the fitted equations for providing the predicted effective pressure.

The invention has been presented in broad language up to now. The invention will be described in greater detail below so that the invention may be further illustrated. An advantage of the GRNN lies in the fact that whereas conventional nonlinear regression techniques involve a priori specification of the structure of the regression equations to yield a best fit for the data presented, the GRNN circumvents these restrictions by adjusting the surface dimension in which the regression surface resides without constraining it to a specific form. Generalization is optimized by modifying the smoothing factor, d, which determines how tightly the network matches its predictions to the data in the training patterns. A three-layer structure was used in the development of the neural network: an input layer, a hidden layer, and an output layer. The input variables selected for the ANN were based on similar parameters used in the regression equation published earlier. Intervening layers of processors, called hidden units, detect higher-order features in the input layer, analyze the signal, and relay the output to other neurons to make a correct response. The number of neurons in the hidden layer is determined by the number of patterns in the training set as GRNNs require one neuron per pattern processed. The output of the GRNN provides an estimate of the effective pressure for the CPAP device to reduce or abolish apneic events. The network was subsequently validated in 99 patients with very good accuracy.

The technique can be used as an extension of a previous algorithm we have developed to predict sleep apnea. When combined with the diagnostic software, the package will consist of an algorithm that would predict the severity of sleep apnea and an algorithm that will determine the most effective pressure for abolishing sleep apnea. This technique is cost effective, simple, ability to be widely implemented, non invasive, time saving, and requires little or no training curve.

The invention is further described by the following non-limiting example. We developed an artificial neural network based on 311 patients that underwent successful sleep titration. A general regression neural network (GRNN) was used in the development of the artificial neural network, or in other words, the predictive model.

In areas of complex interactions, the artificial neural network (ANN) has been found to be a more appropriate alternative to linear, parametric statistical tools due to its inherent property of seeking information embedded in relations among variables thought to be independent. Neural networks are computation systems that process information in parallel, using large numbers of simple units, and that excel in tasks involving pattern recognition. These intrinsic properties of the neural networks have been translated into a higher performance accuracy in outcome prediction compared with expert opinion or conventional statistical methods (8,9). Hence, we hypothesized that the ability to estimate the effective pressure (P_{eff}) can improved by using computer analyses involving neural networks. To test this hypothesis, we first applied an artificial neural network to the analysis of data from patients with documented OSA and validated it prospectively on a separate cohort. Second, we compared the predictive accuracy of an ANN to the previously published predictive model of CPAP titration.

Study Population

The derivation cohort included consecutive patients who underwent a CPAP titration for documented obstructive sleep apnea by polysomnography between January 2005 and August 2005 at a University sleep center. The validation cohort represented patients with OSA who underwent titration study between September 2005 and November of 2005 at a private sleep laboratory. Demographic information (age, gender) and anthropomorphic measurements (neck circumference, height, and weight) were obtained from the computerized data records which included also the initial apnea-hypopnea index (AHI) on the diagnostic study and the set of pressures used during the CPAP titration. The estimated effective pressure derived from the regression equation (P_{pred(RE)}=(0.16×NC)+(0.13×BMI)+(0.04×AHI)-5.12) was calculated also.

Sleep Studies and CPAP Titration

All participants underwent standard overnight polysomnography with recordings of EEG, electro-oculogram, submental and bilateral leg electromyograms, and ECG. Airflow was measured qualitatively by an oral-nasal thermistor and respiratory effort by thoracoabdominal piezoelectric belts (Piezo Crystals, EPM Systems, Midlothian, Va.). Measurement of arterial oxyhemoglobin saturation was performed with a pulse oximeter (ASC: Nellcor N-200, Nellcor Puritan Bennett, St. Louis, Mo.). All signals were collected and digitized on a computerized polysomnography system (ASC: Rembrandt, Aerosep Corporation, Buffalo, N.Y.). Sleep stages were recorded in 30-second epochs using the Rechtschaffen and Kales sleep scoring criteria (10). Each epoch was analyzed for the number of apneas, hypopneas, arousals, and oxygen desaturation. Apnea was defined as the absence of airflow for more than 10 seconds. Hypopnea was defined as a visible reduction in airflow lasting at least 10 seconds associated with either a 4% decrease in arterial oxyhemoglobin saturation or an EEG arousal. An arousal was defined according to the criteria proposed by the Atlas Task Force (11).

CPAP titration was conducted on a subsequent night in the sleep laboratory. Patients were initiated at a pressure of 4 cm H₂O. The pressure was gradually increased by 1 cm H₂O every 20 minutes until such a level at which sleep-disordered breathing events were eliminated in both non-rapid-eye movement and rapid-eye movement sleep. The effective pressure (P_{eff}) was defined as the lowest pressure at which the patient had an AHI <5. Patients who failed to achieve a P_{eff} during CPAP titration were not included in the analysis.

Design of the Artificial Neural Network

A general regression neural network (GRNN) was used in the development of the predictive model (12) using commercially available software (Neuroshell 2, Ward Systems, Frederick, Md.). The advantage of the GRNN lies in the fact that whereas conventional nonlinear regression techniques involve a priori specification of the structure of the regression equations to yield a best fit for the data presented, the GRNN circumvents these restrictions by adjusting the surface dimension in which the regression surface resides without constraining it to a specific form. Generalization is optimized by modifying the smoothing factor, d, which determines how tightly the network matches its predictions to the data in the training patterns.

A three-layer structure was used in the development of the neural network: an input layer, a hidden layer, and an output layer. The input variables selected for the ANN were based on similar parameters used in the regression equation published by Miljeteig and colleagues (Miljeteig). Intervening layers of processors, called hidden units, detected higher-order features in the input layer, analyzed the data, and relayed the output to other neurons to make a correct response. The number of neurons in the hidden layer is determined by the number of patterns in the training set as GRNNs require one neuron per pattern processed. The output layer of the GRNN was structured to provide an estimate of the effective pressure for the CPAP device to reduce or abolish apneic events.

A five-fold cross-validation approach was used for evaluation (13). The entire data set of the derivation group was divided using a random number generator into five subsets. Four of the five subsets were pooled and used for training. The data from the 5th subset were used as an evaluation set during training. The entire process was repeated four additional times by rotating the subset that was used as the evaluation set during training. The mean square error was computed for each of the five artificial neural networks on the entire derivation data set. The mean square errors were averaged, and the artificial neural network that had a mean square error closest to the average was selected.

Statistical Analysis

Data were summarized as mean ±SD (“standard deviation”). For continuous variables, difference in mean values was assessed using Student's t test or the Mann Whitney U test. Categorical values were compared using the chi-square or the Fisher exact test when appropriate. Comparisons between P_{eff} and P_{pred(ANN)}, and P_{eff} and P_{pred(RE)} were made using the paired t test or the Wilcoxon test when indicated. A spearman correlation was performed to assess the relation between the actual effective pressure and the predicted pressures (ANN and RE). Agreement between measurements was assessed also by the method of Bland and Altman (14). Statistical significance was set at p<0.05 (two-tail).

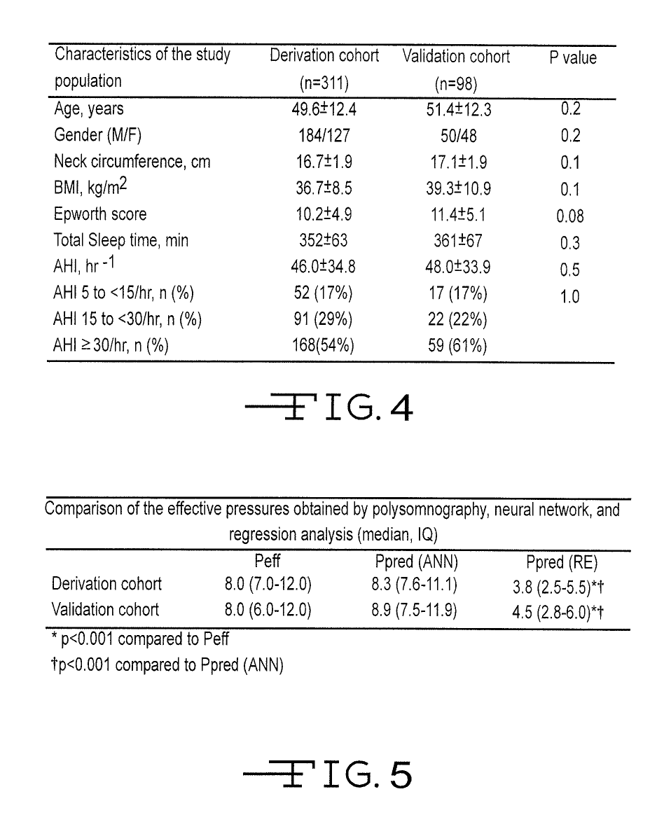

A total of 343 patients were identified for inclusion in the derivation cohort. Twenty nine patients were excluded because of failure to achieve a pressure setting where the AHI ≦5 events/hr and two did not complete the titration study. As for the validation group, an effective pressure was not attained in seven out of the 105 patients. FIG. 4 displays the characteristics of the study population. There were no significant differences in age, gender ratio, neck circumference, body mass index (BMI), or total sleep time between the derivation and the validation cohort. The distribution of the sleep apnea severity was also comparable between the two groups.

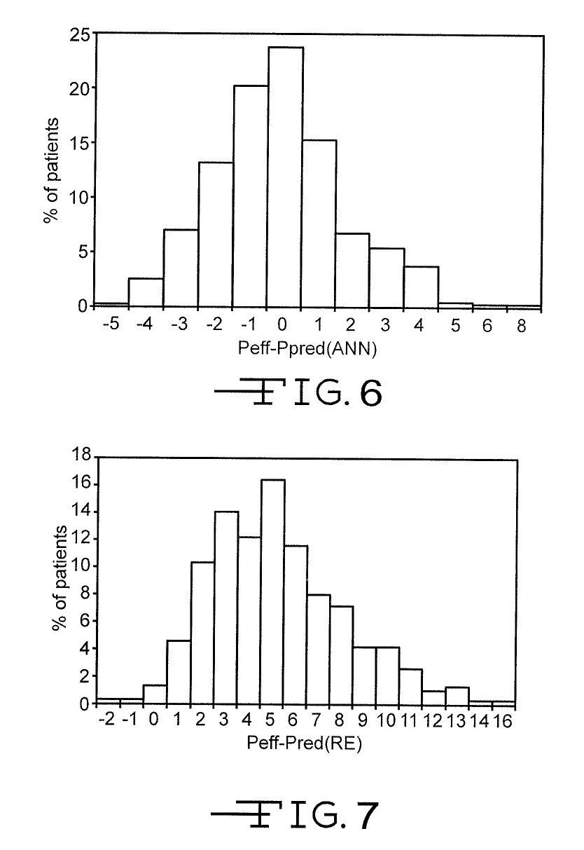

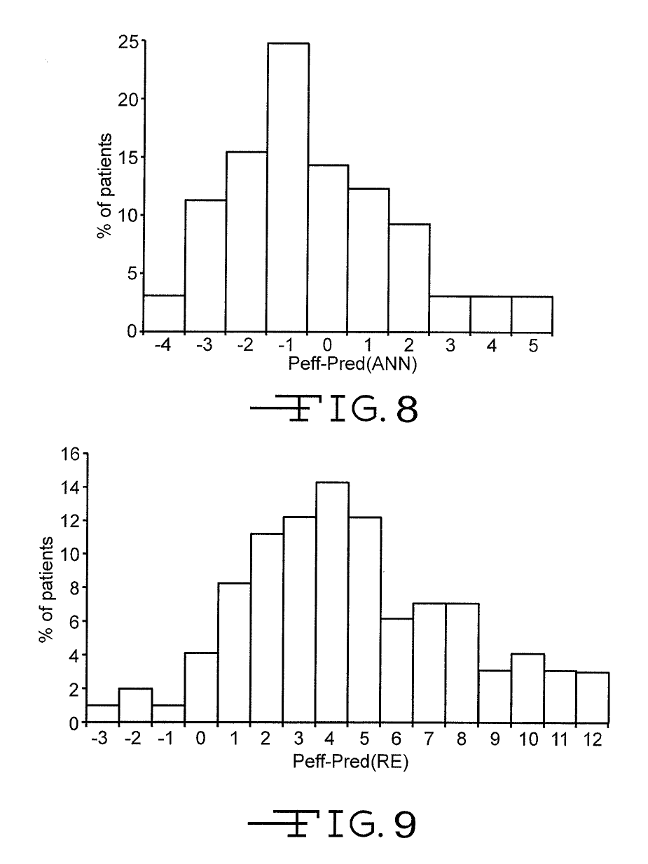

Five variables were selected to form the input layer: age, gender, BMI, neck circumference, and baseline AHI. The mean square error of the artificial neural network selected was 3.8. The predicted effective pressures by the artificial neural network for the derivation and the validation cohort are presented in FIG. 5. There was no significant difference between the effective pressure obtained during an overnight polysomnography and the predicted pressure estimated by the artificial neural network. However, the estimated pressure derived from the regression equation underestimated the effective pressure in both the derivation and the validation group respectively. The histograms of the differences between P_{eff} and P_{pred(ANN)} and P_{eff} and P_{pred(RE)} for the derivation group and validation group are shown in FIGS. 6-7 and FIGS. 8-9, respectively. The correlation coefficient between P_{eff} and P_{pred(ANN)} in the derivation cohort was 0.86 (95% confidence interval [CI] 0.83-0.88; p<0.001) compared to 0.62 (95% CI 0.54-0.68; p<0.001) for the correlation coefficient between P_{eff} and P_{pred(RE)}. In the validation cohort, the correlation coefficients between P_{eff} and P_{pred(ANN)} and P_{eff} and P_{pred(RE)} were 0.85 (95% CI 0.78-0.9; P<0.001) and 0.6 (95% CI 0.53-0.76; p<0.001) respectively.

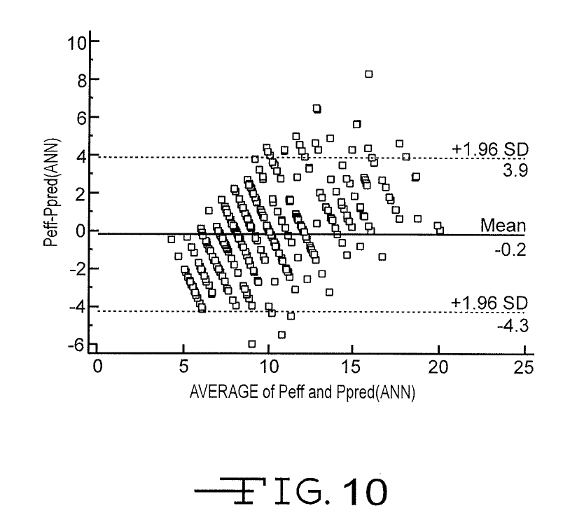

FIG. 10 shows the level of agreement between the P_{eff} and P_{pred(ANN)} using the Bland and Altman analysis for the entire cohort. FIG. 10 reveals that the majority of the estimated pressures by the artificial neural network fall within 95% confidence interval from the calculated paired pressure mean.

The optimal prescription for CPAP therapy in patient with OSA is that which most effectively prevents the adverse consequences of OSA while causing the least discomfort and the lowest risk of complications. A central element of the CPAP prescription is the pressure level which typically derived through a titration study. Various solutions have been proposed as alternatives to conventional titration: “partial-night” trials (15), automatic titration with auto-CPAP devices (16), and pressure prediction using mathematical formulas (Oliver(17)). The present study is the first to present a validated artificial neural network to predict effective CPAP that relies on a combination of anthropomorphic and clinical data, the majority of which have been found to be significantly correlated with optimal CPAP (Miljeteig).

The findings of the study point to high performance accuracy of the artificial neural network when compared with overnight polysomnography. When applied to CPAP titration, the pressure established by the neural network fell within 3 cm of H₂O above or below the optimal pressure set by polysomnography for 92% of the patients. In contrast, the overall accuracy of the regression equation was poor as only 40% of patients had their estimated pressure fall within 3 cm of H₂O of the optimal pressure determined by overnight sleep study. These results coincide with the observations of previously published validation studies from other sleep centers (Gockcebbay, rowley). Overall the regression equation tended to underestimate the effective pressure in both the derivation and the validation cohort. We attribute the deterioration in the predictive ability of the regression equation to the phenomenon of “model drift”. The model drift could stem from either a modified definition of apneas/hypopneas, an improved sensitivity of diagnostic tools, or change in the disease pattern. It has been argued also that the discrepancy in optimum pressure prediction by the regression equation may be attributed to a difference in the population under study. Considering that the derivation of the regression equation was performed in a mostly male population, a preponderance of female participants might have skewed the CPAP prediction as women tend to have a lower severity of sleep apnea and smaller neck circumference (18,19). While the gender distribution of our population was equivalent in both cohorts, the artificial neural network included a gender adjustment to account for inherent differences in sleep characteristics.

The exclusion of patients with unsuccessful titration in our study might explain the higher level of accuracy of the neural network compared to the regression equation. Analysis of those patients who were excluded did not however reveal a common pattern or characteristic. Yet, the rate of CPAP titration failure in our study was lower than those reported in other series of 16% to 40%. In the absence of information addressing this question in the current literature, we attribute this difference to the process of quality improvement and continuous in-service education instituted at these laboratories. A prospective implementation of the neural network will be required to assess the impact of this technology on the rate of CPAP titration failure.

A major departure from previous studies is the cutoff we have used to define titration success. We have selected an AHI <5/hr compared to AHI ≦10/hr used in other studies. Despite the fact that an AHI ≦10/hr was considered as the criterion for defining OSA in screening studies (20,21) or for successful titration when relying on mathematical formulas (Oliver, rowley), we stipulated that the likelihood of achieving a clinically significant effective pressure is increased when AHI of ≦5/hr was targeted, requiring thus fewer number of pressure increments during a titration study.

There are several potential limitations to the study. Neural networks have the ability to approximate predictive output to any desirable degree of accuracy when provided with enough running time. This could result in overfitting, particularly when there is an attempt to increase the processing power of the network by adding a large number of hidden neurons. In this case, the network will end up learning not only the training set but also the noise in the data, which leads to poor generalization. The accuracy of prediction observed in the validation set points however tends to argue against this possibility and reinforces the fact that the network architecture is based on robust features rather than memorizing the idiosyncrasies embedded in the data set. A frequently cited limitation in the literature is the fact that little is known about the pathways used by the ANN to predict outcome (22). These pathways are complex and do not convey an understanding of the structure of reasoning. Unlike the logistic regression equation, the relations between variables are not explicit. The superior predictive ability of the artificial neural network however would offset this limitation. With the wide availability of computers and modern software in medical practice, the neural network algorithm can be easily implemented for daily use.

In summary, the proposed artificial neural network outperformed the traditional regression equation in predicting optimal CPAP. The high level of agreement between our artificial neural network and overnight polysomnography indicates that the artificial neural network may be used to facilitate the titration study by providing baseline pressure from which to start CPAP titration.

The following references are cited in this disclosure:
1. Young T, Palta M, Dempsey J, et al. The occurrence of sleep-disorderd breathing among middle-aged adults. N Engl J Med 1993; 328: 1230-1235.
2. Wright J, Johns R, Melville A, et al. Health effects of obstructive sleep apnea and the effectiveness of continuous positive airway pressure: a systematic review of the research evidence. BMJ 1997; 314: 851-860.
3. Jenkinson C, Davies R J, Mullins R, et al. Comparison of therapeutic and subtherapeutic nasal continuous positive airway pressure for obstructive sleep apnoea: a randomised prospective parallel trial. Lancet 1999; 353: 2100-5.
4. Montserrat J, Ferrer M, Hernandez L, et al. Effectiveness of CPAP treatment in daytime function in sleep apnea syndrome: a randomized controlled study with an optimized placebo. Am J Respir Crit Care Med 2001; 164:608-13.
5. Miljeteig H, Hoffstein V. Determinants of continuous positive airway pressure level for treatment of obstructive sleep apnea. Am Rev Respir Dis 1993; 147: 1526-1530.
6. Rowley J, Tarbichi A, Badr S. The use of a predicted CPAP equation improves CPAP titration success. Sleep Breath 2005; 9: 26-32.
7. Gokcebay N, Iqbal S, Yang K, Zebrak A, Hirshkowitz M. Accuracy of CPAP predicted from anthropometric and polysomnographic indices. Sleep 1996; 19:600-601.
8. Baxt W G. Use of an artificial neural network for the diagnosis of myocardial infarction. Ann Intern Med 1991; 1115:843-848.
9. Rutledge R, Fakhry S. The use of neural networking and polynomial regression to predict the outcome in the critically ill: a comparison with APACHE II [abstract]. Crit Care Med 1993; 21(suppl):S213.
10. Rechtschaffen A, Kales A. A manual of standardized technology, techniques and scoring system for sleep stages of human subjects. Los Angeles, Calif.: Brain Information Service, Brain Information Institute, University of California, 1968.
11. The Atlas Task Force. EEG arousals: scoring rules and examples: a preliminary report from the Sleep Disorders Task Force of the American Sleep Disorders Association. Sleep 1992; 15:173-184.
12. Specht, D. A general regression neural network. IEEE Trans Neural Networks, 1991; 2:6, 568-576.
13. Weiss S M, Kulikowski C A. How to estimate the true performance of a learning system. In: Computer systems that learn. Palo Alto, Calif.: Morgan Kaufmann, 1991; 17-49.
14. Bland J, Altman D. Statistical methods for assessing agreement between two methods of clinical measurement. Lancet 1986; 11:307-310.
15. Sanders M H, Kern N B, Costantino J P, Stiller R A, Studnicki K, Coates J, et al. Adequacy of prescribing positive airway pressure therapy by mask for sleep apnea on the basis of a partial-night trial. Am Rev Respir Dis 1993; 147:1169-74.
16. Meurice J C, Marc I, Series F. Efficacy of autoCPAP in the treatment of obstructive sleep apnea/hypopnea syndrome. Am J Resp Crit Care Med 1996; 153: 794-8.
17. Panagou P, Mermingis H, Tsipra S, Psathakis K, Tsintiris K. Prediction of effective continuous positive airway pressure (CPAP) in obstructive sleep apnea syndrome (OSA). Eur Respir J 2005; 26: Suppl. 49, 111s.
18. O'Connor C, Thornley K, Hanley P. Gender differences in the polysomnographic features of obstructive sleep apnea. Am J Respir Crit Care Med 2000; 161: 1465-1472.
19. Rowley J, Aboussouan L, Badr M. The use of clinical prediction formulas in the evaluation of obstructive sleep apnea. Sleep 2000; 23: 929-938.
20. El Solh A, Mador J, Ten-Brock E, Schucard D, Abul-Khoudoud M, Grant BJ. Validity of neural network in sleep apnea. Sleep 1999; 22: 105-111.
21. Flemons W, Whitelaw W, Brant R, Remmers J. Likelihood ratios for a sleep apnea clinical prediction rule. Am J Respir Crit Care Med 1994; 150: 1279-1285.
22. Hart A, Wyatt J. Evaluating black-boxes as medical decision aids: issues arising from a study of neural networks. Med Inform 1990; 15: 229-236.

What is claimed is:

1. A method for evaluating artificial neural networks (“ANNs”) for predicting a continuous positive airway pressure, comprising:
a) collect information from human subjects to provide a dataset that includes an entry for each human subject wherein each entry includes a neck circumference, a body mass index, an apnea-hypopnea index, and an actual effective pressure;
b) randomly separate the entries of the dataset into n subsets;
c) create n (where “n” is an integer) unique training sets, wherein each training set has n−1 of the n subsets;
d) create n ANNs, each of the ANNs being created from a different one of the training sets, and created to provide a predicted effective pressure using information about neck circumference, body mass index and apnea-hypopnea index;
e) calculate a mean squared error for each of the n ANNs by comparing the predicted effective pressure to the actual effective pressure for each of the entries;
f) calculate an average by averaging the mean squared errors;
g) determine which of the mean squared errors is closest to the average; and,
h) select the ANN corresponding to the mean squared error that is determined to be closest to the average.

2. The method of claim 1, wherein the mean squared error for an ANN is calculated by:
i) selecting one of the entries;
ii) calculating the predicted effective pressure for the selected entry;
iii) calculating an error number, the error number being an error between the actual effective pressure and the calculated predicted effective pressure of the selected entry;
iv) repeating the steps 1-3 for each of the entries to provide a plurality of error numbers; and,
v) calculating a mean squared error using the plurality of error numbers.

3. The method of claim 1, wherein the selected ANN is used to predict an effective pressure for treating obstructive sleep apnea.

4. The method of claim 1, wherein the entries of the dataset are separated into n subsets by:
i) assigning each entry a randomly generated number;
ii) assigning each of n subsets a range of randomly generated numbers; and,
iii) assigning each entry into one of the subsets based on the range and the randomly generated number.

5. The method of claim 1, wherein the entries of the dataset are separated into n subsets by:
i) assigning each entry a randomly generated number;
ii) assigning each of n subsets a range of randomly generated numbers; and,
iii) assigning each entry into one of the subsets based on the range and the randomly generated number, wherein the ranges of randomly generated numbers are arranged to provide an equal number of entries assigned to each of the n subsets.

6. The method of claim 1, wherein the ANNs are created by modifying coefficients of the equation:
P_{predicted}=X·NC+Y·BMI+Z·AHI+C, wherein P_{predicted} is the predicted pressure for one of the human subjects, NC is the neck circumference for one of the human subjects, BMI is the body mass index for one of the human subjects, AHI is the apnea-hypopnea index for one of the human subjects, and X, Y, Z, and C are the coefficients.

7. The method of claim 1, wherein the ANNs are created by a general regression neural network.

8. The method of claim 7, wherein the general regression neural network includes an input layer, a hidden layer, and an output layer.

9. The method of claim 8, wherein the input layer extracts the information contained within each entry of the dataset.

10. The method of claim 8, wherein the hidden layer fits an equation to each entry of the dataset.

11. The method of claim 8, wherein the output layer provides an estimate equation responsive to the fitted equations for providing the predicted effective pressure.

12. A method of predicting a continuous positive airway pressure, comprising creating an artificial neural network that produces a predicted continuous positive airway pressure.

13. The method of claim 12, further comprising using the artificial neural network to produce a predicted continuous positive airway pressure.

14. The method of claim 12, wherein the artificial neural network is created using a dataset, the dataset including information collected from human subjects, the information including an entry for each human subject wherein each entry includes a neck circumference, a body mass index, an apnea-hypopnea index, and an actual effective pressure.

15. The method of claim 12, wherein the artificial neural network is created using a general regression neural network.

16. The method of claim 15, wherein the general regression neural network includes an input layer, a hidden layer, and an output layer.

17. The method of claim 16, wherein the input layer extracts the information contained within each entry of the dataset.

18. The method of claim 16, wherein the hidden layer fits an equation to each entry of the dataset.

19. The method of claim 16, wherein the output layer provides the predicted continuous positive airway pressure.
